(19) United States
(12) Patent Application Publication
(10) Pub. No.: US 2022/0417586 A1
(43) Pub. Date: Dec. 29, 2022

(54) NON-OCCLUDING VIDEO OVERLAYS

(71) Applicant: Google LLC, Mountain View, CA (US)

(72) Inventors: Elena Erbiceanu-Tener, Los Gatos, CA (US); Alexandre Galashov, London (GB); Andy Chiu, Redwood City, CA (US); Nathan Wiegand, San Jose, CA (US)

(21) Appl. No.: 17/776,652

(22) PCT Filed: Jul. 29, 2020
(86) PCT No.: PCT/US2020/044068

§ 371 Date: May 13, 2022

(51) Int. Cl. H04N 21/431; G06V 20/40; G06V 30/14; G06V 40/10; G06V 10/82; G06V 10/22; H04N 21/44

(52) U.S. Cl. CPC H04N 21/4316; G06V 20/41; G06V 30/1448; G06V 40/10; G06V 10/82; G06V 10/225; H04N 21/44008

(57) ABSTRACT

Methods, systems, and computer media provide for identifying exclusion zones in frames of a video, aggregating those exclusion zones for a specified duration or number of frames, defining a inclusion zone within which overlaid content is eligible for inclusion, and providing overlaid content for inclusion in the inclusion zone. The exclusion zones can include regions in which significant features are detected such as text, human features, objects from a selected set of object categories, or moving objects.

### BACKGROUND

Videos that are streamed to a user can include additional content that is overlaid on top of the original video stream. The overlaid content may be provided to the user within a rectangular region that overlays and blocks a portion of the original video screen. In some approaches, the rectangular region for provision of the overlaid content is positioned at the center bottom of the video screen. If important content of the original video stream is positioned at the center bottom of the video screen, it can be blocked or obstructed by the overlaid content.

### SUMMARY

This specification describes technologies related to overlaying content on top of a video stream, while at the same time avoiding areas of the video screen that feature useful content in the underlying video stream, e.g., areas in the original video stream that contain faces, text, or significant objects such as fast-moving objects.

In general, a first innovative aspect of the subject matter described in this specification can be embodied in methods that include identifying, for each video frame among a sequence of frames of a video, a corresponding exclusion zone from which to exclude overlaid content based on the detection of a specified object in a region of the video frame that is within the corresponding exclusion zone; aggregating the corresponding exclusion zones for the video frames in a specified duration or number of the sequence of frames; defining, within the specified duration or number of the sequence of frames of the video, an inclusion zone within which overlaid content is eligible for inclusion, the inclusion zone being defined as an area of the video frames in the specified duration or number that is outside of the aggregated corresponding exclusion zones; and providing overlaid content for inclusion in the inclusion zone of the specified duration or number of the sequence of frames of the video during display of the video at a client device. Other implementations of this aspect include corresponding apparatus, systems, and computer programs, configured to perform the aspects of the methods, encoded on computer storage devices.

In some aspects, the identifying of the exclusion zones can include identifying, for each video frame in the sequence of frames, one or more regions in which text is displayed in the video, the methods further including generating one or more bounding boxes that delineate the one or more regions from other parts of the video frame. The identifying of the one or more regions in which text is displayed can include identifying the one or more regions with an optical character recognition system.

In some aspects, the identifying of the exclusion zones can include identifying, for each video frame in the sequence of frames, one or more regions in which human features are displayed in the video, the methods further including generating one or more bounding boxes that delineate the one or more regions from other parts of the video frame. The identifying the one or more regions in which human features are displayed can include identifying the one or more regions with a computer vision system trained to identify human features. The computer vision system can be a convolutional neural network system.

In some aspects, the identifying of the exclusion zones can include identifying, for each video frame in the sequence of frames, one or more regions in which significant objects are displayed in the video, wherein identifying of the regions in which significant objects are displayed is identifying with a computer vision system configured to recognize objects from a selected set of object categories not including text or human features. The identifying of the exclusion zones can include identifying the one or more regions in which the significant objects are displayed in the video, based on detection of objects that move more than a selected distance between consecutive frames or detection of objects that move during a specified number of sequential frames.

In some aspects, the aggregating of the corresponding exclusion zones can include generating a union of bounding boxes that delineate the corresponding exclusion zones from other parts of the video. The defining of the inclusion zone can include identifying, within the sequence of frames of the video, a set of rectangles that do not overlap with the aggregated corresponding exclusion zones over the specified duration or number; and the providing overlaid content for inclusion in the inclusion zone can include: identifying an overlay having dimensions that fit within one or more rectangles among the set of rectangles; and providing the overlay within the one or more rectangles during the specified duration or number.

The subject matter described in this specification can be implemented in particular embodiments so as to realize one or more of the following advantages.

While a user is viewing a video stream that fills a video screen, the content of value to the user within that video screen area may not fill the entire area of the video screen. For example, the valuable content, e.g., faces, text, or significant objects such as fast-moving objects, may occupy only a portion of the video screen area. There is an opportunity, therefore, to present additional useful content to the user in the form of overlaid content that does not obstruct the portion of the video screen area that contains the valuable underlying content. Aspects of the present disclosure provide the advantage of identifying exclusion zones from which to exclude overlaid content, because overlaying content over these exclusion zones would block or obscure valuable content that is included in the underlying video stream, which would result in wasted computing resources by delivering video to users when the valuable content is not perceivable to the users. In some situations, machine learning engines (such as Bayesian classifiers, optical character recognition systems, or neural networks) can identify interesting features within the video stream, such as faces, text, or other significant objects; exclusion zones can be identified that encompass these interesting features; and then the overlaid content can be presented outside of these exclusion zones. As a result, the user can receive the overlaid content without obstruction of the valuable content of the underlying video stream, such that the computing resources required to deliver the video are not wasted. This results in a more efficient video distribution system that prevents computing system resources (e.g., network bandwidth, memory, processor cycles, and limited client device display space) from being wasted through the delivery of videos in which the valuable content is occluded, or otherwise not perceivable by the user.

This has the further advantage of improving the efficiency of the screen area in terms of the bandwidth of useful content delivered to the viewer. If the user is viewing a video in which, as is typical, the valuable content of the video occupies only a fraction of the viewing area, the available bandwidth to deliver useful content to the viewer is underutilized. By using machine learning systems to identify that fraction of the viewing area that contains the valuable content of the underlying video stream, aspects of the present disclosure provide for overlaying additional content outside of that fraction of the viewing area, leading to more efficient utilization of the screen area to deliver useful content to the viewer.

In some approaches, the overlaid content includes a box or other icon that the viewer can click to remove the overlaid content, for example, if the overlaid content obstructs valuable content in the underlying video. A further advantage of the present disclosure is that, because the overlaid content is less likely to obstruct valuable content in the underlying video, there is less disruption of the viewing experience and a greater likelihood that the viewer will not “click away” the overlaid content that has been presented.

Various features and advantages of the foregoing subject matter are described below with respect to the figures. Additional features and advantages are apparent from the subject matter described herein and the claims.

### BRIEF DESCRIPTION OF THE DRAWINGS

FIG. 1 depicts an overview of aggregating exclusion zones and defining an inclusion zone for a video that includes a sequence of frames.

FIG. 2 depicts an example of frame-by-frame aggregation of exclusion zones for the example of FIG. 1.

FIG. 3 depicts an example of a machine learning system for identifying and aggregating exclusion zones and selecting overlaid content.

FIG. 4 depicts a flow diagram for a process that includes aggregating exclusion zones and selecting overlaid content.

FIG. 5 is a block diagram of an example computer system.

Like reference numbers and designations in the various drawings indicate like elements.

### DETAILED DESCRIPTION

It is generally desirable to provide overlaid content on an underlying video stream, to provide additional content to a viewer of the video stream and to improve the quantity of content delivered within the viewing area for a given video streaming bandwidth. However, there is a technical problem of determining how to place the overlaid content so that it does not occlude valuable content in the underlying video. This is a particularly difficult problem in the context of overlaying content on video because the locations of important content in a video can change quickly over time. As such, even if a particular location within the video is a good candidate for overlay content at one point in time, that location may be a bad candidate for overlay content at a later point in time (e.g., due to movement of characters within the video).

The present specification presents a solution to this technical problem by describing machine learning methods and systems that can identify exclusion zones that correspond to regions of the video stream that are more likely to contain valuable content; aggregating these exclusion zones over time; and then positioning the overlaid content in an inclusion zone that is outside of the aggregated exclusion zones, so that the overlaid content is less likely to obstruct valuable content in the underlying video.

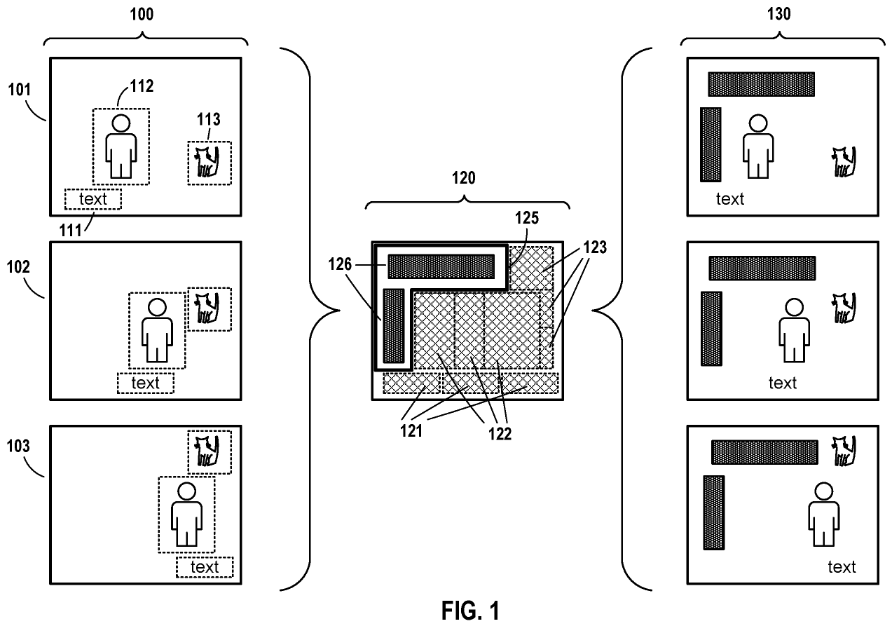

FIG. 1 depicts an illustrative example of exclusion zones, inclusion zones, and overlaid content for a video stream. In this example, an original, underlying video stream 100 is depicted as frames 101, 102, and 103 on the left side of the figure. Each frame can include regions that are likely to contain valuable content that should not be occluded by overlaid content features. For example, the frames of the video may include one or more regions of text 111, such as closed caption text or text that appears on features within a video, e.g., text that appears on product labels, road signs, white boards on screen within a video of a school lecture, etc. Note that features within the video are part of the video stream itself, whereas any overlaid content is separate from the video stream itself. As further discussed below, a machine learning system such as an optical character recognition (OCR) system can be used to identify regions with the frames that contain text, and that identifying can include identifying bounding boxes that enclose the identified text, as shown. As illustrated in the example of FIG. 1, the text 111 might be situated at different locations within the different frames, so overlaid content that persists for a duration of time that includes multiple frames 101, 102, 103 should not be positioned anywhere that the text 111 is situated across the multiple frames.

Other regions that should not be occluded by overlaid content features (e.g., to ensure that the important content of the underlying video are not occluded) are regions 112 that include persons or human features. For example, the frames may include one or more persons, or portions thereof, such as human faces, torsos, limbs, hands, etc. As further discussed below, a machine learning system such as a convolutional neural network (CNN) system can be used to identify regions within the frames that contain persons (or portions thereof, such as faces, torsos, limbs, hands, etc.), and that identifying can include identifying bounding boxes that enclose the identified human features, as shown. As illustrated in the example of FIG. 1, the human features 112 might be situated at different locations within the different frames, so overlaid content that persists for a duration of time that includes multiple frames 101, 102, 103 should not be positioned anywhere that the human features 112 are situated across the multiple frames. In some approaches, the human features 112 may be discriminated by limiting the human features detection to larger human features, i.e. features that are in the foreground and closer to the point of view of the video, as opposed to background human features. For example, larger human faces corresponding to persons in the foreground of a video may be included in the detection scheme, while smaller human faces corresponding to persons in the background of a video, such as faces in a crowd, may be excluded from the detection scheme.

Other regions that should not be occluded by overlaid content features are regions 113 that contain other potential objects of interest, such as animals, plants, street lights or other road features, bottles or other containers, furnishings, etc. As further discussed below, a machine learning system such as a convolutional neural network (CNN) system can be used to identify regions within the frames that contain potential objects of interest. For example, a machine learning system can be trained to classify various objects selected from a list of object categories, e.g. to identify dogs, cats, vases, flowers, or any other category of object that may be of potential interest to the viewer. The identifying can include identifying bounding boxes that enclose the detected objects, as shown. As illustrated in the example of FIG. 1, the detected object 113 (a cat in this example) might be situated at different locations within the different frames, so overlaid content that persists for a duration of time that includes multiple frames 101, 102, 103 should not be positioned anywhere that the detected objects 113 are situated across the multiple frames.

In some approaches, the detected objects 113 may be discriminated by limiting the object detection to objects that are in motion. Objects that are in motion are generally more likely to convey important content to the viewer and therefore potentially less suitable to be occluded by overlaid content. For example, the detected objects 113 can be limited to objects that move a certain minimum distance within a selected interval of time (or selected interval of frames), or that move during a specified number of sequential frames.

As illustrated by the video screen 120 in FIG. 1, exclusion zones from which to exclude overlaid content can be identified based on the detected features in the video that are more likely to be of interest to the viewer. Thus, for example, the exclusion zones can include regions 121 in which text has been identified as appearing in frames of the video (compare with identified text 111 in original video frames 101, 102, 103); the exclusion zones can also include regions 122 in which human features have been identified as appearing in frames of the video (compare with identified human features 112 in original video frames 101, 102, 103); and the exclusion zones can also include regions 123 in which other objects of interest (such as faster-moving objects, or objects identified from a selected list of object categories) have been identified as appearing in frames of the video (compare with identified object 113 in original video frames 101, 102, 103).

Because the overlaid content may be included for a selected duration of time (or a selected number of frames of the underlying video), the exclusion zones can be aggregated over the selected duration of time (or selected span of frames) to define an aggregate exclusion zone. For example, the aggregate exclusion zone can be the union of all exclusion zones corresponding to detected features of interest in each video frame among a sequence of frames of a video. The selected duration of time could be 1 second, 5 seconds, 10 seconds, 1 minute, or any other duration of time that is suitable for display of the overlaid content. Alternatively, a selected span of frames could be 24 frames, 60 frames, 240 frames, or any other span of frames that is suitable for display of the overlaid content. A selected duration of time can correspond to a selected span of frames, or vice versa, as determined by a frame rate of the underlying video. While the example of FIG. 1 shows aggregation over only three frames 101, 102, 103, this is only for purposes of illustration and is not intended to be limiting.

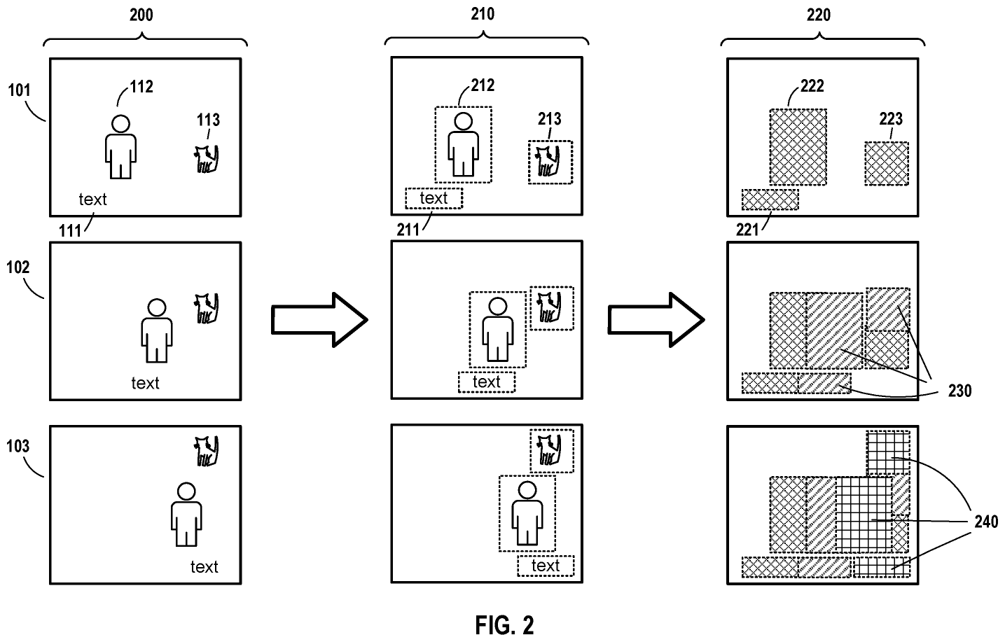

FIG. 2 presents an example of how the aggregation of exclusion zones can proceed frame-by-frame of the example of FIG. 1. First, a minimum number of consecutive frames can be selected over which exclusion zones can be aggregated (or, in some situations, a minimum interval of time can be selected, and converted to a number of consecutive frames based upon the video frame rate). In this example, for purposes of the illustration only, the minimum number of consecutive frames is three frames, corresponding to frames 101, 102, and 103 as shown.

As shown in column 200 of FIG. 2, each frame 101, 102, and 103 in the underlying video frame may contain features of interest such as text 111, human features 112, or other potential objects of interest 113. For each frame, a machine learning system such as an optical character recognition system, a Bayesian classifier, or a convolutional neural network classifier, can be used to detect the features of interest within the frame. As shown in column 210 of FIG. 2, the detection of a feature within a frame can include determining a bounding box that encloses the feature. Thus, the machine learning system can output bounding boxes 211 enclosing detected text each frame, bounding boxes 212 enclosing human features 112 within each frame, and/or bounding boxes 213 enclosing other potential objects of interest 213 within each frame. The bounding boxes 212 enclosing human features 112 can be selected to enclose the entirety of any human features detected within the frame, or they can be selected to enclose only a portion of any human features detected within the frame (e.g. enclosing only faces, heads and shoulders, torsos, hands, etc.). As shown in column 220 of FIG. 2, the bounding boxes 211, 212, 213 for the consecutive frames can correspond to exclusion zones 221, 222, 223, respectively, which can be accumulated or aggregated frame-by-frame, with newly-added exclusion zones 230 being accumulated for exclusion zones of frame 102 and newly-added exclusion zones 240 being accumulated for exclusion zones of frame 103, so that as seen in the rightmost bottom frame of FIG. 2, the aggregation includes all bounding boxes for all features detected within all frames within the selected interval of consecutive frames. Note that in this example, the aggregated exclusion zones seen at bottom right of FIG. 2 are the aggregated exclusion zones for frame 101 for the selected interval of consecutive frames (three in this instance). Thus, for frame 102, for example, the aggregated exclusion zones would include the single-frame exclusion zones of frame 102, frame 103, and a fourth frame that is not shown; similarly, the aggregated exclusion zones for frame 102 would include the single-frame exclusion zones of frame 103, a fourth frame that is not shown, and a fifth frame that is not shown; and so on.

Having aggregated exclusion zones over a selected duration of time or selected span of frames, an inclusion zone can be defined within which overlaid content is eligible for display. For example, the inclusion zone 125 in FIG. 1 corresponds to a region of the viewing area 120 in which neither text 111, human features 112, or other objects of interest 113 appears across the span of frames 101, 102, 103.

In some approaches, the inclusion zone can be defined as a set of inclusion zone rectangles whose union defines the entirety of the inclusion zone. The set of inclusion zone rectangles can be calculated by iterating over all of the bounding boxes (e.g. rectangles 211, 212, and 213 in FIG. 2) that have been accumulated to define the aggregate exclusion zone. For a given bounding box in the accumulated bounding boxes, select the top right corner as a starting point (x,y), and then expand up, left, and right to find the largest box that does not overlap any of the other bounding boxes (or the edge of the viewing area), and add that largest box to the list of inclusion zone rectangles. Next, select the bottom right corner as a starting point (x,y), and then expand up, down, and right to find the largest box that does not overlap any of the other bounding boxes (or the edge of the viewing area), and add that largest box to the list of inclusion zone rectangles. Next, select the top left corner as a starting point (x,y), and then expand up, left, and right to find the largest box that does not overlap any of the other bounding boxes (or the edge of the viewing area), and add that largest box to the list of inclusion zone rectangles. Next, select the bottom left corner as a starting point (x,y), and then expand down, left, and and right to find the largest box that does not overlap any of the other bounding boxes (or the edge of the viewing area), and add that largest box to the list of inclusion zone rectangles. Then repeat these steps for the next bounding box in the accumulation of bounding boxes. Note that these steps can be completed in any order. The inclusion zone thus defined is an inclusion zone for frame 101 because it defines areas in which overlaid content can be positioned in frame 101 and subsequent frame for the selected interval of consecutive frames (three in this instance) without occluding any detected features in any of frames 101, 102, 103, i.e. within any frames within the selected interval of consecutive frames. An inclusion zone for frame 102 can be similarly defined but it would involve the complement of single-frame exclusion zones for frame 102, frame 103, and a fourth frame that is not shown; similarly, an inclusion zone for frame 103 would involve the complement of single-frame exclusion zones for frame 103, a fourth frame that is not shown, and a fifth frame that is not shown; and so on.

With the inclusion zone defined, suitable overlaid content can be selected for display within the inclusion zone. For example, a set of candidate overlaid content may be available, where each item in the set of candidate overlaid content has specifications that can include, for example, the width and height of each item, a minimum duration of time during which each item would be provided to the user, etc. One or more items from the set of candidate overlaid content may be selected to fit within the defined inclusion zone. For example, as shown in viewing area of FIG. 1, two items of overlaid content 126 might be selected to fit within the inclusion zone 105. In various approaches, the number of overlaid content features may be limited to one, two, or more features. In some approaches, a first overlaid content feature may be provided during a first span of time (or span of frames), and a second overlaid content feature may be provided during a second span of time (or span of frames), etc., and the first, second, etc. spans of time (or spans of frames) may be completely overlapping, partially overlapping, or non-overlapping.

Having selected the overlaid content 126 to be provided to the viewer along with the underlying video stream, FIG. 1 depicts an example of a video stream 130 that includes both the underlying video and the overlaid content. As illustrated in this example, the overlaid content 126 does not occlude or obstruct the features of interest that were detected in the underlying video 100 and used to define exclusion zones for the overlaid content.

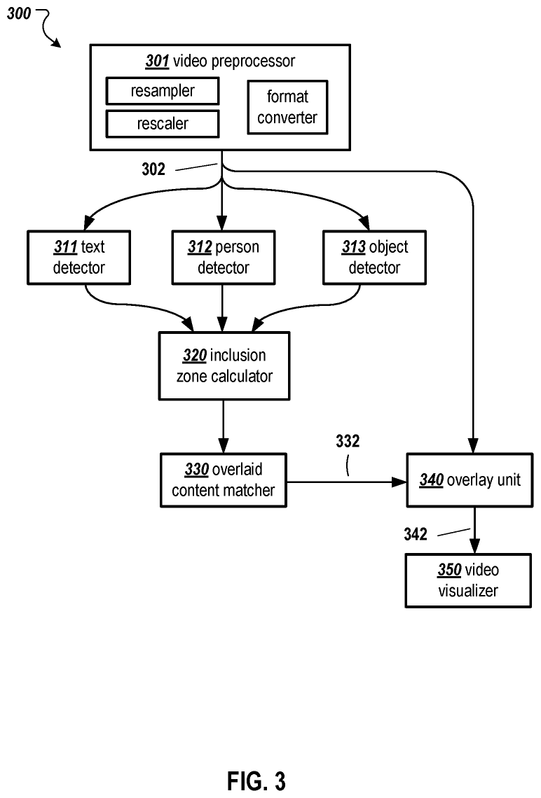

With reference now to FIG. 3, an illustrative example is depicted as a block diagram for a system of selecting inclusion zones and providing overlaid content on a video stream. The system may operate as a video pipeline, receiving, as input, an original video on which to overlay content, and providing, as output, a video with overlaid content. The system 300 can include a video preprocessor unit 301 which may be used to provide for downstream uniformity of video specifications, such as frame rate (which may be adjusted by a resampler), video size/quality/resolution (which may be adjusted by a rescaler), and video format (which may be adjusted by a format converter). The output of the video preprocessor is a video stream 302 in a standard format for further processing by the downstream components of the system.

The system 300 includes a text detector unit 311 that receives as input the video stream 302 and provides as output a set of regions in which text appears in the video stream 302. The text detector unit can be a machine learning unit, such as an optical character recognition (OCR) module. For purposes of efficiency, the OCR module need only find regions in which text appears in the video without actually recognizing the text that is present within those regions. Once the regions have been identified, the text detector unit 311 can generate (or specify) a bounding box delineating (or otherwise defining) the regions within each frame that have been determined to include text, which can be used in identifying exclusion zones for overlaid content. The text detector unit 311 can output the detected text bounding boxes as, for example, as an array (indexed by frame number) where each element of the array is a list of the rectangles defining text bounding boxes detected within that frame. In some approaches, the detected bounded boxes can be added to the video stream as metadata information for each frame of the video.

The system 300 also includes a person or human features detector unit 312 that receives as input the video stream 302 and provides as output a set of regions of the video that contain persons (or portions thereof, such as faces, torsos, limbs, hands, etc.). The person detector unit can be a computer vision system such as a machine learning system, e.g., a Bayesian image classifier or convolutional neural network (CNN) image classifier. The person or human features detector unit 312 can be trained, for example, on labeled training samples that are labeled with the human features depicted by the training samples. Once trained, the person or human features detector unit 312 can output a label identifying one or more human features that are detected in each frame of a video and/or a confidence value indicating the level of confidence that the one or more human features are located within each frame. The person or human features detector unit 312 can also generate a bounding box delineating an area in which the one or more human features have been detected, which can be used in identifying exclusion zones for overlaid content. For purposes of efficiency, the human features detector unit need only find regions in which human features appear in the video without actually recognizing the identities of persons that are present within those regions (e.g. recognizing the faces of specific persons that are present within those regions).The human features detector unit 312 can output the detected human features bounding boxes as, for example, as an array (indexed by frame number) where each element of the array is a list of the rectangles defining human features bounding boxes detected within that frame. In some approaches, the detected bounded boxes can be added to the video stream as metadata information for each frame of the video.

The system 300 also includes an object detector unit 313 that receives as input the video stream 302 and provides as output a set of regions of the video that contain potential objects of interest. The potential objects of interest can be objects that are classified as belonging to an object category in a selected list of object categories (e.g. animals, plants, road or terrain features, containers, furnishings, etc.). The potential objects of interest can also be limited to identified objects that are in motion, e.g. objects that move a certain minimum distance within a selected interval of time (or selected interval of frames) or that move during a specified number of sequential frames in the video stream 302. The object detector unit can be a computer vision system such as a machine learning system, e.g., a Bayesian image classifier or convolutional neural network image classifier. The object detector unit 313 can be trained, for example, on labeled training samples that are labeled with objects that are classified as belonging to an object category in a selected list of object categories. For example, the object detector can be trained to recognize animals such as cats or dogs; or the object detector can be trained to recognize furnishings such as tables and chairs; or the object detector can be trained to recognize terrain or road features such as trees or road signs; or any combination of selected object categories such as these. The object detector unit 313 can also generate bounding boxes delineating (or otherwise specifying) areas of video frames in which the identified objects have been identified. The object detector unit 312 can output the detected object bounding boxes as, for example, as an array (indexed by frame number) where each element of the array is a list of the rectangles defining object bounding boxes detected within that frame. In some approaches, the detected bounded boxes can be added to the video stream as metadata information for each frame of the video. In other illustrative examples, system 300 may comprise at least one of text detector 311, person detector 312 or object detector 313.

The system 300 also includes an inclusion zone calculator unit or module 320 that receives input from one or more of the text detector unit 311 (with information about regions in which text appears in the video stream 302), the person detector unit 312 (with information about regions in which persons or portions thereof appear in the video stream 302), and the object detector unit 313 (with information about regions in which various potential objects of interest appear in the video stream 302). Each of these regions can define an exclusion zone; the inclusion zone calculator unit can aggregate those exclusion zones; and then the inclusion zone calculator can define an inclusion zone within which overlaid content is eligible for inclusion.

The aggregated exclusion zone can be defined as the union of a list of rectangles that each include a potential interesting feature such as text, a person, or another object of interest. It may be represented as an accumulation of bounding boxes that are generated by the detector units 311, 312, and 313, over a selected number of consecutive frames. First, the bounding boxes can be aggregated for each frame. For example, if the text detector unit 311 outputs a first array (indexed by frame number) of lists of text bounding boxes in each frame, the human features detector 312 outputs a second array (indexed by frame number) of lists of human features bounding boxes in each frame, and the object detector unit 313 outputs a third array (indexed by frame number) of lists of bounding boxes for detected objects in each frame, these first, second, and third arrays can be merged to define a single array (again indexed by frame number), where each element is a single list that merges all bounding boxes for all features (text, human, or other object) detected within that frame. Next, the bounded boxes can be aggregated over a selected interval of consecutive frames. For example, a new array (again index by frame number) might be defined, where each element is a single list that merges all bounding boxes for all features detected within frames i, i+1, i+2, . . . , i+(N−1), where N is the number of frames in the selected interval of consecutive frames. In some approaches, the aggregated exclusion zone data can be added to the video stream as metadata information for each frame of the video.

The inclusion zone calculated by the inclusion zone calculator unit 320 can be then be defined as the complement of the accumulation of bounding boxes that are generated by the detector units 311, 312, and 313, over a selected number of consecutive frames. The inclusion zone can be specified, for example, as another list of rectangles, the union thereof forming the inclusion zone; or as a polygon with horizontal and vertical sides, which may be described, e.g., by a list of vertices of the polygon; or as a list of such polygons if the inclusion zone, e.g., if the inclusion zone includes disconnected areas of the viewing screen. If the accumulated bounded boxes are represented, as discussed above, by an array (indexed by frame number) where each element is a list that merges all bounding boxes for all features detected within that frame and within the following N−1 consecutive frames, then the inclusion zone calculator unit 320 can store the inclusion zone information as a new array (again indexed by frame number) where each element is a list of inclusion rectangles for that frame, taking into account all of the bounding boxes accumulated over that frame and the following N−1 consecutive frames by iterating over each accumulated bounding box and over the four corners of each bounding box, as discussed above in the context of FIG. 2. Note that these inclusion zone rectangles can be overlapping rectangles that collectively define the inclusion zone. In some approaches, this inclusion zone data can be added to the video stream as metadata information for each frame of the video.

The system 300 also includes an overlaid content matcher unit or module 330 that receives input from the inclusion zone calculator unit or module 320, for example, in the form of a specification for an inclusion zone. The overlaid content matcher unit can select suitable content for overlay on the video within the inclusion zone. For example, the overlaid content matcher may have access to a catalog of candidate overlaid content, where each item in the catalog of candidate overlaid content has specifications that can include, for example, the width and height of each item, a minimum duration of time during which each item should be provided to the user, etc. The overlaid content matcher unit can select one or more items from the set of candidate overlaid content to fit within the inclusion zone provided by the inclusion zone calculator unit 320. For example, if the inclusion zone information is stored in an array (index by frame number), where each element in the array is a list of inclusion zone rectangles for that frame (taking into account all of the bounding boxes accumulated over that frame and the following N−1 consecutive frames), then, for each item in the catalog of candidate overlaid content, the overlaid content matcher can identify inclusion zone rectangles within the array that are large enough to fit the selected item; they can be ranked in order of size, and/or in order of persistence (e.g. if the same rectangle appears in multiple consecutive elements of the array, indicating that the inclusion zone is available for even more than the minimum number of consecutive frames N), and then an inclusion zone rectangle can be selected from that ranked list for inclusion of the selected overlaid content. In some approaches, the overlaid content may be scalable, e.g. over a range of possible x or y dimension or over a range of possible aspect ratios; in these approaches, an inclusion zone rectangle matching the overlaid content item may be selected to the, for example, the largest area inclusion zone rectangle that could fit the scalable overlaid content, or the inclusion zone rectangle of sufficient size that can persist for the longest duration of consecutive frames.

The system 300 also includes an overlay unit 340 which receives as input both the underlying video stream 302 and the selected overlaid content 332 (and location(s) thereof) from the overlaid content matcher 330. The overlay 340 can then provide a video stream 342 that includes both the underlying video content 302 and the selected overlaid content 332. At the user device, a video visualizer 350 (e.g. a video player embedded within a web browser, or a video app on a mobile device) displays the video stream with the overlaid content to the user. In some approaches, the overlay unit 340 may reside on the user device and/or be embedded within the video visualizer 350; in other words, both the underlying video stream 302 and the selected overlaid content 332 may be delivered to the user (e.g. over the internet), and they may be combined on the user device to display an overlaid video to the user.

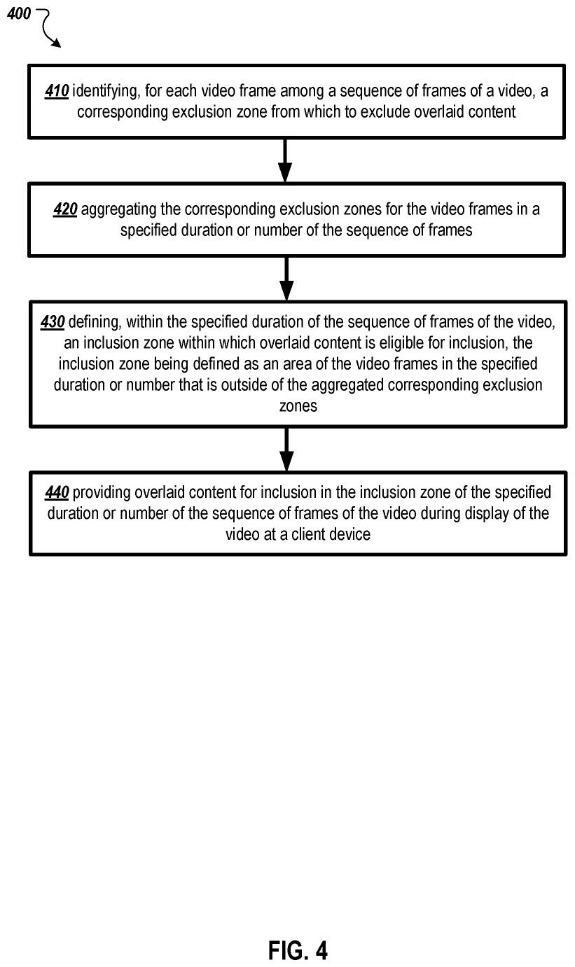

With reference now to FIG. 4, an illustrative example is depicted as a process flow diagram for a method of providing overlaid content on a video stream. The process includes 410—identifying, for each video frame among a sequence of frames of a video, a corresponding exclusion zone from which to exclude overlaid content. For example, inclusion zones can correspond to regions of the viewing area containing features of the video that are more likely to be of interest to the viewer, such as regions contain text (e.g. regions 111 in FIG. 1), regions containing persons or human features (e.g. regions 112 in FIG. 1), and regions containing particular objects of interest (e.g. regions 113 in FIG. 1). These regions can be detected, for example, using machine learning systems such as an OCR detector for text (e.g. text detector 311 in FIG. 3), a computer vision system for person or human features (e.g. person detector 312 in FIG. 3), and a computer vision system for other objects of interest (e.g. object detector 313 in FIG. 3).

The process also includes 420—aggregating the corresponding exclusion zones for the video frames in a specified duration or number of the sequence of frames. For example, as shown in FIG. 1, rectangles 121, 122, and 123 that are bounding boxes of potential features of interest can be aggregated over a sequence of frames to define an aggregate exclusion zone that is a union of the exclusion zones for the sequence of frames. This union of the exclusion zone rectangles can be calculated, for example, by the inclusion zone calculator unit 320 of FIG. 3.

The process further includes 430—defining, within the specified duration or number of the sequence of frames of the video, an inclusion zone within which overlaid content is eligible for inclusion, the inclusion zone being defined as an area of the video frames in the specified duration or number that is outside of the aggregated corresponding exclusion zones. For example, the inclusion zone 125 in FIG. 1 can be defined as a complement of the aggregated exclusion zones, and the inclusion zone may be described as a union of rectangles that collectively fill the inclusion zone. The inclusion zone may be calculated, for example, by the inclusion zone calculator unit 320 of FIG. 3.

The process further includes 440—providing overlaid content for inclusion in the inclusion zone of the specified duration or number of the sequence of frames of the video during display of the video at a client device. For example, overlaid content may be selected from a catalog of candidate overlaid content, based, e.g., on dimensions of the items in the catalog of candidate overlaid content. In the example of FIG. 1, two overlaid content features 126 are selected for inclusion within the inclusion zone 125. The overlaid content (and its positioning within the viewing area) may be selected by the overlaid content matcher 330 of FIG. 3, and the overlay unit 340 can superimpose the overlaid content on top of the underlying video stream 302 to define a video stream 342 with overlaid content to be provided to the user for viewing on a client device.

In some approaches, the overlaid content that is selected from the catalog of overlaid content may be chosen in the following manner. For a frame i, an inclusion zone may be defined as a union of a list of inclusion area rectangles, which are the rectangles that do not intersect any of the exclusion zones (bounding boxes for detected objects) in frames i, i+1, . . i+(N−1), where N is a selected minimum number of consecutive frames. Then for a frame i and for a given candidate item from the catalog of overlaid content, the inclusion area rectangles are selected from the list of inclusion area rectangles that could fit the candidate item. These are inclusion area rectangles that could fit the candidate item for the selected minimum number of consecutive frames N. The same process can be performed for frame i+1; then, by taking an intersection of the results for frame i and for frame i+1, a list of inclusion area rectangles can be obtained that could fit the candidate item for N+1 consecutive frames. Again performing an intersection with the results for frame i+2, a set of inclusion areas that could fit the candidate item for N+2 consecutive frames can be obtained. The process can be iterated for any selected span of frames (including the entire duration of the video) to obtain rectangles suitable for inclusion of the candidate item for frame durations N, N+1, . . . , N+(k−1) where N+k is the longest possible duration. Thus, for example, a location for the overlaid content may be selected from the list of inclusion area rectangles that can persist for the longest duration without occluding detected features, i.e. for N+k frames.

In some approaches, more than one content feature may be included at the same time. For example, a first item of overlaid content may be selected, and then a second item of overlaid content may be selected by defining an additional exclusion zone that encloses the first item of overlaid content. In other words, the second item of overlaid content may be placed by regarding the video overlaid with the first item of overlaid content as a new underlying video suitable for overlay of additional content. The exclusion zone for the first item of overlaid content may be made significantly larger than the overlaid content itself, to increase the spatial separation between different items of overlaid content within the viewing area.

In some approaches, the selecting of overlaid content may include selecting that allows a specified level of encroachment on an exclusion zone. For example, some area-based encroachment could be tolerated by weighing inclusion zone rectangles by the extent to which the overlaid content spatially extends outside of each inclusion zone rectangle. Alternatively or additionally, some time-based encroachment could be tolerated by ignoring ephemeral exclusion zones that only exist for a relatively short time. For example, if the exclusion zone is only defined for a single frame out of 60 frames, it could be lower weighted and therefore more likely to be occluded than an area in which the exclusion zone exists for the entire 60 frames. Alternatively or additional, some content-based encroachment could be tolerated by ranking the relative importance of different types of exclusion zones corresponding to different types of detected features. For example, detected text features could be ranked as more important than detected non-text features, and/or detected human features could be ranked as more important than detected non-human features, and/or more rapidly moving features could be ranked as more important than more slowly moving features.

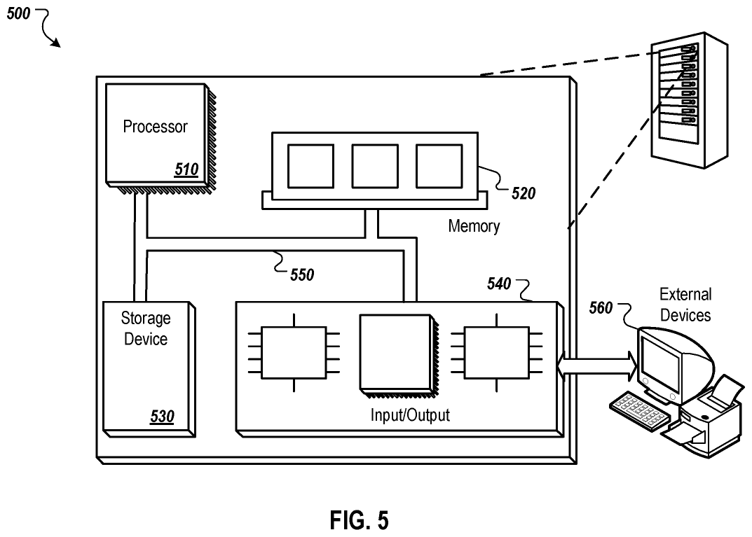

FIG. 5 is a block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In some implementations, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In some implementations, the memory 520 is a volatile memory unit. In another implementation, the memory 520 is a non-volatile memory unit.

The storage device 530 is capable of providing mass storage for the system 500. In some implementations, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In some implementations, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to external devices 460, e.g., keyboard, printer and display devices. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. The computer storage media (or medium) may be transitory or non-transitory. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method, comprising:
identifying, for each video frame among a sequence of frames of a video, a corresponding exclusion zone from which to exclude overlaid content based on the detection of a specified object in a region of the video frame that is within the corresponding exclusion zone;
aggregating the corresponding exclusion zones for the video frames in a specified duration or number of the sequence of frames;
defining, within the specified duration or number of the sequence of frames of the video, an inclusion zone within which overlaid content is eligible for inclusion, the inclusion zone being defined as an area of the video frames in the specified duration or number that is outside of the aggregated corresponding exclusion zones; and
providing overlaid content for inclusion in the inclusion zone of the specified duration or number of the sequence of frames of the video during display of the video at a client device.

2. The method of claim 1, wherein identifying the exclusion zones includes identifying, for each video frame in the sequence of frames, one or more regions in which text is displayed in the video, the method further comprising generating one or more bounding boxes that delineate the one or more regions from other parts of the video frame.

3. The method of claim 2, wherein identifying the one or more regions in which text is displayed comprises identifying the one or more regions with an optical character recognition system.

4. The method of claim 1, wherein identifying the exclusion zones includes identifying, for each video frame in the sequence of frames, one or more regions in which human features are displayed in the video, the method further comprising generating one or more bounding boxes that delineate the one or more regions from other parts of the video frame.

5. The method of claim 4, wherein identifying the one or more regions in which human features are displayed comprises identifying the one or more regions with a computer vision system trained to identify human features.

6. The method of claim 5, wherein the computer vision system is a convolutional neural network system.

7. The method of claim 1, wherein identifying of the exclusion zones includes identifying, for each video frame in the sequence of frames, one or more regions in which significant objects are displayed in the video, wherein identifying of the regions in which significant objects are displayed is identifying with a computer vision system configured to recognize objects from a selected set of object categories not including text or human features.

8. The method of claim 7, wherein identifying of the exclusion zones includes identifying the one or more regions in which the significant objects are displayed in the video, based on detection of objects that move more than a selected distance between consecutive frames or detection of objects that move during a specified number of sequential frames.

9. The method of claim 1, wherein aggregating the corresponding exclusion zones includes generating a union of bounding boxes that delineate the corresponding exclusion zones from other parts of the video.

10. The method of claim 9, wherein:
defining the inclusion zone includes identifying, within the sequence of frames of the video, a set of rectangles that do not overlap with the aggregated corresponding exclusion zones over the specified duration or number; and
providing overlaid content for inclusion in the inclusion zone comprises:
identifying an overlay having dimensions that fit within one or more rectangles among the set of rectangles; and
providing the overlay within the one or more rectangles during the specified duration or number.

11. A system, comprising:
one or more processors; and
one or more memories having stored thereon computer readable instructions configured to cause the one or more processors to perform operations comprising:
identifying, for each video frame among a sequence of frames of a video, a corresponding exclusion zone from which to exclude overlaid content based on the detection of a specified object in a region of the video frame that is within the corresponding exclusion zone;
aggregating the corresponding exclusion zones for the video frames in a specified duration or number of the sequence of frames;
defining, within the specified duration or number of the sequence of frames of the video, an inclusion zone within which overlaid content is eligible for inclusion, the inclusion zone being defined as an area of the video frames in the specified duration or number that is outside of the aggregated corresponding exclusion zones; and
providing overlaid content for inclusion in the inclusion zone of the specified duration or number of the sequence of frames of the video during display of the video at a client device.

12. (canceled)

13. The system of claim 11, wherein identifying the exclusion zones includes identifying, for each video frame in the sequence of frames, one or more regions in which text is displayed in the video, the method further comprising generating one or more bounding boxes that delineate the one or more regions from other parts of the video frame.

14. The method of claim 13, wherein identifying the one or more regions in which text is displayed comprises identifying the one or more regions with an optical character recognition system.

15. The system of claim 11, wherein identifying the exclusion zones includes identifying, for each video frame in the sequence of frames, one or more regions in which human features are displayed in the video, the method further comprising generating one or more bounding boxes that delineate the one or more regions from other parts of the video frame.

16. The system of claim 15, wherein identifying the one or more regions in which human features are displayed comprises identifying the one or more regions with a computer vision system trained to identify human features.

17. A non-transitory computer readable medium storing instructions that upon execution by one or more computers cause the one or more computers to perform operations comprising:
identifying, for each video frame among a sequence of frames of a video, a corresponding exclusion zone from which to exclude overlaid content based on the detection of a specified object in a region of the video frame that is within the corresponding exclusion zone;
aggregating the corresponding exclusion zones for the video frames in a specified duration or number of the sequence of frames;
defining, within the specified duration or number of the sequence of frames of the video, an inclusion zone within which overlaid content is eligible for inclusion, the inclusion zone being defined as an area of the video frames in the specified duration or number that is outside of the aggregated corresponding exclusion zones; and
providing overlaid content for inclusion in the inclusion zone of the specified duration or number of the sequence of frames of the video during display of the video at a client device.

18. The non-transitory computer readable medium of claim 17, wherein identifying the exclusion zones includes identifying, for each video frame in the sequence of frames, one or more regions in which text is displayed in the video, the method further comprising generating one or more bounding boxes that delineate the one or more regions from other parts of the video frame.

19. The non-transitory computer readable medium of claim 18, wherein identifying the one or more regions in which text is displayed comprises identifying the one or more regions with an optical character recognition system.

20. The non-transitory computer readable medium of claim 17, wherein identifying the exclusion zones includes identifying, for each video frame in the sequence of frames, one or more regions in which human features are displayed in the video, the method further comprising generating one or more bounding boxes that delineate the one or more regions from other parts of the video frame.

21. The non-transitory computer readable medium of claim 20, wherein identifying the one or more regions in which human features are displayed comprises identifying the one or more regions with a computer vision system trained to identify human features.
